(19) United States
(12) Patent Application Publication
(10) Pub. No.: US 2009/0285622 A1
(43) Pub. Date: Nov. 19, 2009

(54) APPLICATOR UNIT

(75) Inventors: Robert Frederick Veasey, Warwickshire (GB); John David Cross, Coventry (GB); Robert Perkins, Warwickshire (GB)

Correspondence Address: NOVARTIS;CORPORATE INTELLECTUAL PROPERTY, ONE HEALTH PLAZA 104/3, EAST HANOVER, NJ, 07936-1080, US

(73) Assignee: Novartis AG, Basel (CH)

(21) Appl. No.: 12/304,158

(22) PCT Filed: Jun. 28, 2007
(86) PCT No.: PCT/EP07/05743

§ 371 Date: Dec. 10, 2008

(30) Foreign Application Priority Data
Jun. 30, 2006 (GB) 0613153.6

(51) Int. Cl. A46B 11/00; G01F 11/00

(52) U.S. Cl. 401/266; 222/386; 401/268

(57) ABSTRACT

An applicator unit for use in applying a substance to a surface, the applicator unit comprising: a body unit to which a container is movably disposed; an outlet unit which includes an applicator element to which substance is dispensed; and a pump unit which is operative to dispense substance to the applicator element on applying an actuation force to the container.

The present invention relates to an applicator unit for use in applying a substance, in particular a viscous substance, such as a pharmaceutical product or a cosmetic product, to a surface, such as a human nail.

WO-A-2004/062422 discloses an applicator device for applying a nail polish. This applicator device includes a pump mechanism for delivering nail polish to a brush for subsequent application to a nail.

It is an aim of the present invention to provide an improved device, which inter alia is of simpler construction.

In one aspect the present invention provides an applicator unit for use in applying a substance to a surface, the applicator unit comprising: a body unit to which a container is movably disposed; an outlet unit which includes an applicator element to which substance is dispensed; and a pump unit which is operative to dispense substance to the applicator element on applying an actuation force to the container.

Preferably, the pump unit is operative to dispense preferably a metered volume of substance.

In one embodiment the pump unit comprises a body section which includes a substance-containing cavity and a plunger member which includes a plunger which is movable relative to the substance-containing cavity, such that, on moving the plunger into the substance-containing cavity, substance is dispensed from the substance-containing cavity to the outlet unit.

In one embodiment the body section of the pump unit is fixed in relation to the body unit and the plunger member is coupled to the container such as to be movable therewith, such that the plunger is moved into the substance-containing cavity on applying an actuation force to the container.

In one embodiment the pump unit comprises a coupling member which comprises the body section, an attachment section which is attached to the container such as to be movable therewith and a flexible section which connects the body section to the attachment section, such as to allow for movement of the attachment section relative to the body section.

In one embodiment the flexible section comprises a resilient section which acts to bias apart the attachment section and the body section.

In one embodiment the pump unit comprises a biasing element which acts to bias the plunger from the substance-containing cavity.

In one embodiment the substance-containing cavity defines a metering chamber, such that, on moving the plunger into the substance-containing cavity to an actuated position, a metered volume of substance is dispensed to the outlet unit.

In one embodiment the applicator element comprises a porous element.

In another embodiment the applicator element comprises a brush element.

In a further embodiment the applicator element comprises a blade.

In a further embodiment the applicator element comprises a paddle.

In another aspect the present invention provides an applicator unit for use in applying a substance to a surface, the applicator unit comprising: an outlet unit which includes an applicator element to which substance is dispensed; and a pump unit which is operative to dispense substance to the applicator element.

The present invention also extends to an applicator device comprising the above-described applicator unit and a container for containing a substance.

In one embodiment the container contains a substance.

In one embodiment the substance comprises a pharmaceutical product.

In another embodiment the substance comprises a cosmetic product.

A preferred embodiment of the present invention will now be described hereinbelow by way of example only with reference to the accompanying drawings, in which:

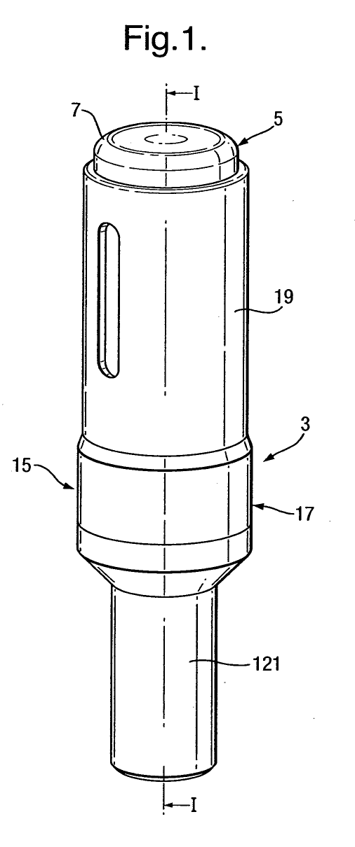

FIG. 1 illustrates a perspective view of an applicator device in accordance with a preferred embodiment of the present invention;

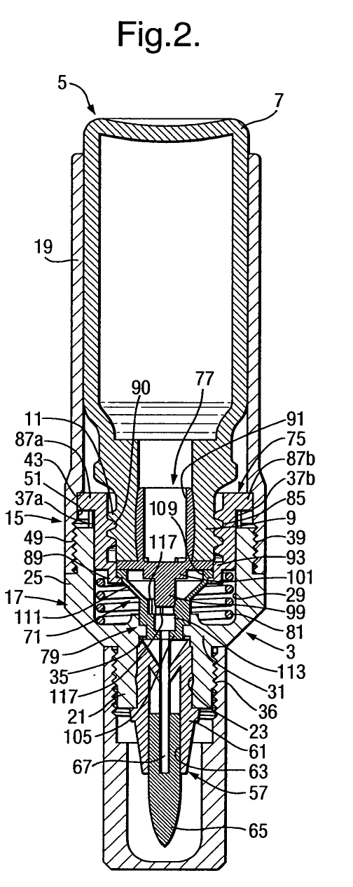

FIG. 2 illustrates a cross-sectional view (along section I-I in FIG. 1) of the applicator device of FIG. 1, where illustrated in the rest or inoperative configuration;

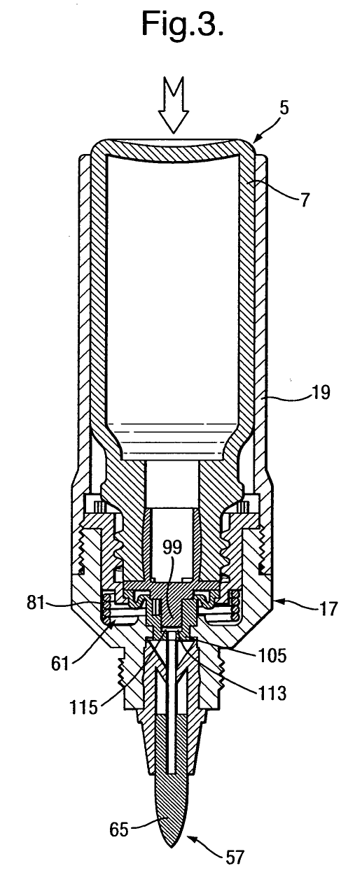

FIG. 3 illustrates a cross-sectional view (along section I-I in FIG. 1) of the applicator device of FIG. 1, where illustrated in the actuated configuration;

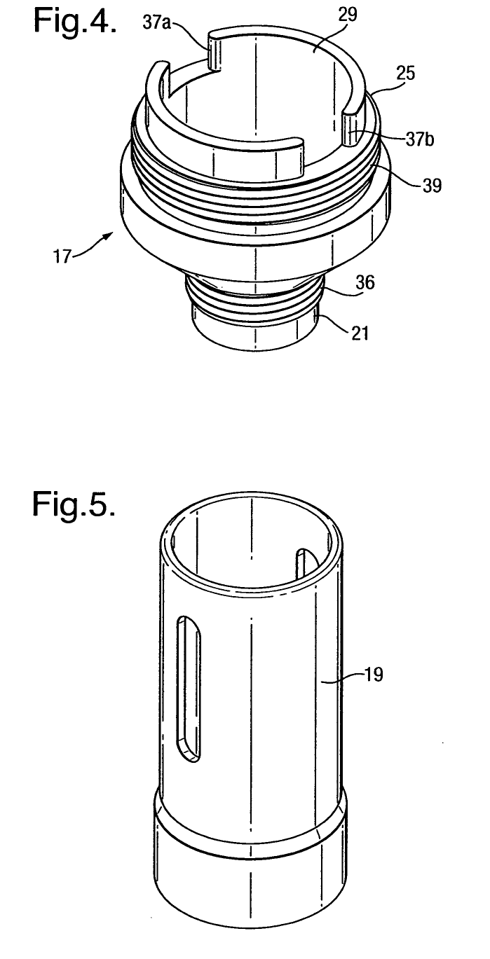

FIG. 4 illustrates a perspective view of the body member of the body unit of the applicator unit of FIG. 1;

FIG. 5 illustrates a perspective view of the sleeve element of the body unit of the applicator unit of FIG. 1;

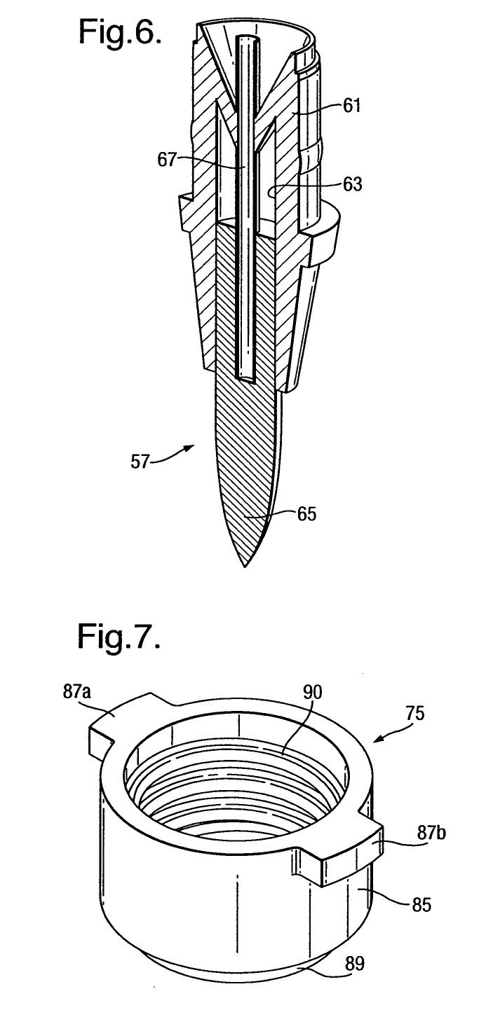

FIG. 6 illustrates a perspective, vertical sectional view of the outlet unit of the applicator unit of FIG. 1;

FIG. 7 illustrates a perspective view of the support member of the pump unit of the applicator unit of FIG. 1;

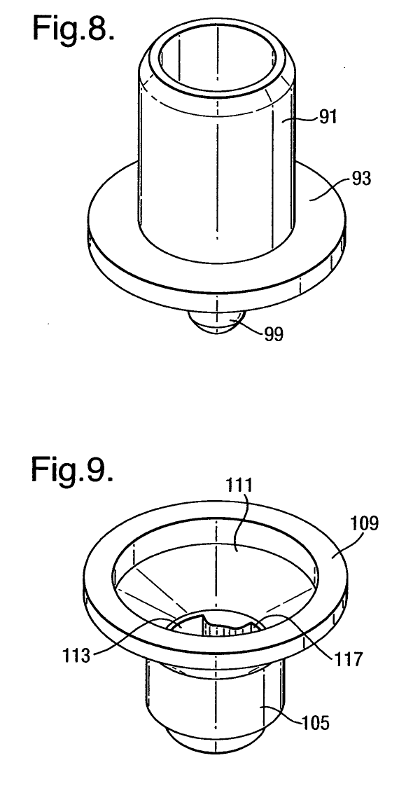

FIG. 8 illustrates a perspective view of the plunger member of the pump unit of the applicator unit of FIG. 1;

FIG. 9 illustrates a perspective view of the coupling member of the pump unit of the applicator unit of FIG. 1;

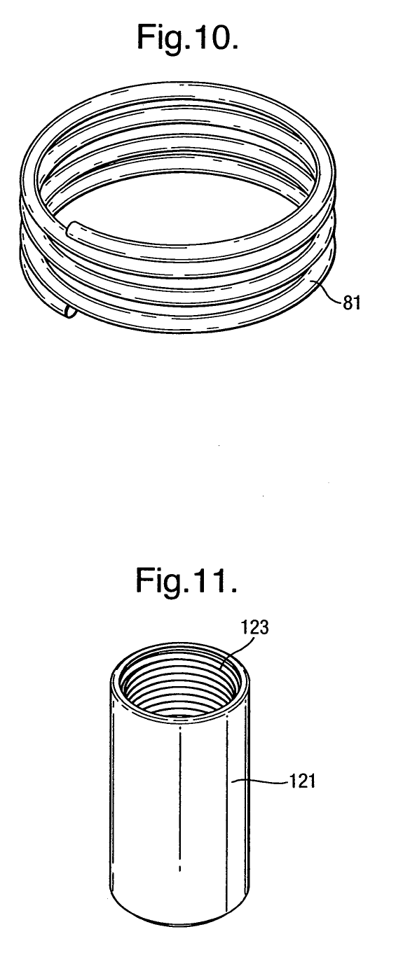

FIG. 10 illustrates a perspective view of a preferred biasing element of the pump unit of the applicator unit of FIG. 1; and

FIG. 11 illustrates a perspective view of the cap of the applicator unit of FIG. 1.

The applicator device comprises an applicator unit 3 and a container 5 which is fluidly connected to the applicator unit 3. In preferred embodiments the container 5 is formed of one of a glass or a plastics material, such as a polypropylene (PP), polyethylene (PE), poly(ethylene terephthalate) (PET), polyamide (PA), ethylene/vinyl alcohol (EVOH), cyclic olefin co-polymer (COC) such as Topas®, or the container can have a multilayered structure by using the plastics described above.

In this embodiment the container 5 comprises an elongate container body 7 and a head member 9 at one, the forward, end of the container body 7, which includes a threaded section 11, in this embodiment as an external thread, which provides for coupling to the applicator unit 3, as will be described in more detail hereinbelow.

The applicator unit 3 comprises a body unit, in this embodiment comprising a body member 17 and a sleeve element 19, which is attached to the body member 17 and acts to shroud a part of the container body 7, in this embodiment a major, forward part of the container body 7, such that only a distal, bottom end of the container body 7 projects therefrom. Optionally in said embodiment, the body member 17 and the sleeve element 19 can be integrated into one single element.

In preferred embodiments the body member 17 and the sleeve element 19 are formed of a plastics material, such as PP, polyacetal (POM), poly(butylene terephthalate) (PBT), PE, PET or polystyrene (PS).

Referring particularly to FIG. 4, the body member 17 includes a first, forward section 21 which includes a first cavity 23, in this embodiment of cylindrical section, and a second, rear section 25 which includes a second cavity 29, in this embodiment of cylindrical section and greater radial dimension than the first cavity 23, and a flange section 31 which is intermediate the first and second cavities 23, 29 and includes a fluid communication aperture 35 which provides for fluid communication between the first and second cavities 23, 29.

In this embodiment the forward section 21 of the body member 17 includes a thread coupling 36, here in the outer peripheral surface thereof.

In this embodiment the rear section 25 of the body member 17 includes at least one slot 37, in this embodiment first and second opposed slots 37a, 37b, which act as guides, as will be described in more detail hereinbelow.

In this embodiment the rear section 25 of the body member 17 includes a thread coupling 39, here in the outer peripheral surface thereof.

The sleeve element 19 includes an abutment surface 43, in this embodiment an annular surface as defined by a flange, in the inner peripheral surface thereof at one, the forward, end thereof, the purpose of which will become apparent hereinbelow.

The sleeve element 19 further includes a thread coupling 49 at the one, forward end thereof, in this embodiment in the inner peripheral surface thereof, which threadedly engages the thread coupling 39 on the rear section 25 of the body member 17. As illustrated in FIGS. 2 and 3, the body member 17 and the sleeve element 19 together define a recess 51 between the rear edge of the rear section 25 of the body member 17 and the abutment surface 43 as defined by the sleeve element 19.

The applicator unit 3 further comprises an outlet unit 57 which is disposed to the forward section 21 of the body member 17, and to which substance is delivered for topical application to a surface, such as a human nail.

Referring particularly to FIG. 6, in this embodiment the outlet unit 57 comprises an attachment member 61 which fits, here as a hermetic sealing fit, in the first cavity 23 of the body member 17 and includes a cavity 63, an applicator element 65, here an elongate element, which is fitted in the cavity 63 and extends forwardly therefrom, and a fluid supply conduit 67 which extends from the rear end of the attachment member 61 and into the body of the applicator element 65.

In a preferred embodiment the attachment member 61 is formed of a plastics material, such as PP, PBT, POM or PE.

In this embodiment the applicator element 65 comprises a porous element, the forward end of which is shaped in the form of a pointed nib. In one embodiment the porous element could be formed from a fibre pad, typically in the form of a felt pad, a sponge or an open-cell foam.

In another embodiment the applicator element 65 could comprise a brush element, where the fluid is delivered into the body of the bristles of the brush element. In one preferred embodiment the bristles could be formed of PA, PET, PP, PE or natural fibers.

In a further embodiment the applicator element 65 could comprise a blade, such as in the form of a resilient blade, where the fluid is delivered to a surface of the blade. In preferred embodiments the blade could be formed of metallocene polyolefin, polyolefin plastomer or thermoplastic polyester elastomer.

The applicator unit 3 further comprises a pump unit 71 which is coupled to the rear section 25 of the body member 17 and the container 5, and, as will be described in more detail hereinbelow, is operative to provide for the delivery of substance to the outlet unit 57.

The pump unit 71 comprises a support element 75 to which the container 5 is attached, a plunger member 77 which is coupled to the container 5 such as to move therewith to provide for displacement of the contained substance with forward movement of the container 5, as will be described in more detail hereinbelow, a coupling member 79 to which the plunger member 77 is at least in part movably disposed to deliver substance to the outlet unit 57, and a biasing element 81 for biasing the support member 75 rearwardly in order to return the pump unit 71 to the rest configuration following actuation of the pump unit 71.

Referring particularly to FIG. 7, the support element 75 comprises a body section 85, in this embodiment of cylindrical section, which is a sliding fit in the second cavity 29 of the body member 17, at least one detent element 87, in this embodiment first and second outwardly-directed flange elements 87a, 87b which are disposed at a rear end of the body section 85 and project through the respective slots 37a, 37b in the rear section 25 of the body member 17 and into the recess 51 at the inner surface of the sleeve element 19 such that the flange elements 87a, b are held captive in the recess 51, and an attachment element 89, in this embodiment an inwardly-directed flange, which acts to engage the coupling member 79.

In this embodiment the body section 85 of the support element 75 includes a thread coupling 90, here in the inner peripheral surface thereof, which is the counterpart of the thread coupling 11 on the head 9 of the container 5, such as to provide for attachment of the support element 75 to the container 5.

In this embodiment the detent elements 87a, 87b hold the support element 75 captive to the body member 17, with the support element 75 being movable between a first position, as illustrated in FIG. 2, in which the support element 75 is biased by the biasing element 81 of the pump unit 71 against the abutment surface 43 of the sleeve element 19, and a second position, as illustrated in FIG. 3, in which the support element 75 is biased forwardly by a manual actuation force F against the bias of the biasing element 81 of the pump unit 71.

Referring particularly to FIG. 8, the plunger member 87 comprises a sleeve element 91, in this embodiment a cylindrical element, which fits into the head 9 of the container 5, in this embodiment as a tight fit, a flange element 93 which extends outwardly of the sleeve element 91 and is configured to be located at the lip of the mouth of the head 9 of the container 5, a plunger 99, in this embodiment a cylindrical element, which projects forwardly of the sleeve element 91 and axially therewith, and a plurality of supporting arms 101 which connect the plunger 99 to the sleeve element 91 and are configured to allow for the transfer of substance thereby.

Referring to FIG. 9, the coupling member 79 comprises a body section 105 which is fluidly connected to the fluid delivery port 35 in the intermediate flange 31 of the body member 17, an attachment section 109, in this embodiment an annular section, which is attached to the attachment element 89 of the support member 75, in this embodiment clamped thereby such as to provide a fluid-tight seal, and a flexible section 111 which connects the body section 105 to the attachment section 109.

The body section 105 includes a cavity 113 which defines a metering chamber 115, in this embodiment of cylindrical section, which is of a predetermined volume and is such that, on insertion of the plunger 99 thereinto, a predetermined volume of substance is metered to the outlet unit 57.

In this embodiment the cavity 113 in the body section 105 also includes at least one, in this embodiment a plurality of channels 117 in the peripheral wall thereof which extend rearwardly from the metering chamber 115, such as to allow for the transfer of substance past the forward end of the plunger 99.

In one embodiment the support element 75 could be formed of PP, PBT, POM or PE.

In one embodiment the plunger member 77 could be formed of PP, PBT, PE or POM.

In one embodiment the coupling member 79 could be formed of a metallocene polyolefin, polyolefin plastomer or thermoplastic polyester elastomer.

Referring particularly to FIG. 11, the applicator unit 3 further comprises a cap 121 which a sealing fit with the body member 17 such as to enclose the applicator element 65 of the outlet unit 57 from the atmosphere.

In this embodiment the cap 121 includes a thread coupling 123, here in the inner peripheral surface thereof, which is counterpart to the thread coupling 36 on the forward section 21 of the body member 17.

In a preferred embodiment the cap 121 is formed of PP, PBT, POM or PE.

Operation of the above-described delivery device will now be described hereinbelow.

With a container 5 fitted to the applicator unit 3, the user first removes the cap 121 from the body member 17 to expose the applicator element 65 of the outlet unit 57.

The user then actuates the pump unit 61 by manually depressing the bottom end of the container 5 though the application of an actuation force F.

As illustrated in FIG. 3, depressing the bottom end of the container 5 acts to drive the plunger 99 of the plunger member 77 forwards in relation to the body section 105 of the coupling member 79. In driving the plunger 99 forwards, the plunger 99 is driven towards the metering chamber 115 of the coupling member 105.

At the point where the forward end of the plunger 99 closes the open, rear end of the metering chamber 115, the metering chamber 115 contains a predetermined volume of substance.

With continued movement of the plunger 99, the volume of substance as contained in the metering chamber 115 is driven therefrom and through the supply conduit 67 of the outlet unit 57 to the applicator element 65 for topical application to a surface, such as a human nail.

On releasing the bottom end of the container 5, the container 5 and the pump unit 61 are returned to the rest configuration, ready for further operation. If further substance is required for application, this procedure is repeated.

Finally, it will be understood that the present invention has been described in its preferred embodiment and can be modified in many different ways without departing from the scope of the invention as defined by the appended claims.

For example, in one alternative embodiment the cap 121 could form part of a stand, such that the applicator unit 3 is ordinarily maintained in a vertical orient. This arrangement is advantageous insofar as the metering chamber 115 always includes substance and there will hence be no need for priming.

1. An applicator unit for use in applying a substance to a surface, the applicator unit comprising:
a body unit to which a container is movably disposed;
an outlet unit which includes an applicator element to which substance is dispensed; and
a pump unit which is operative to dispense substance to the applicator element on applying an actuation force to the container.

2. The applicator unit of claim 1, wherein the pump unit is operative to dispense a metered volume of substance.

3. The applicator unit of claim 2, wherein the pump unit comprises a body section which includes a substance-containing cavity and a plunger member which includes a plunger which is movable relative to the substance-containing cavity, such that, on moving the plunger into the substance-containing cavity, substance is dispensed from the substance-containing cavity to the outlet unit.

4. The applicator unit of claim 3, wherein the body section of the pump unit is fixed in relation to the body unit and the plunger member is coupled to the container such as to be movable therewith, such that the plunger is moved into the substance-containing cavity on applying an actuation force to the container.

5. The applicator unit of claim 4, wherein the pump unit comprises a coupling member which comprises the body section, an attachment section which is attached to the container such as to be movable therewith and a flexible section which connects the body section to the attachment section, such as to allow for movement of the attachment section relative to the body section.

6. The applicator unit of claim 5, wherein the flexible section comprises a resilient section which acts to bias apart the attachment section and the body section.

7. The applicator unit of claim 5, wherein the pump unit comprises a biasing element which acts to bias the plunger from the substance-containing cavity.

8. The applicator unit of claim 3 wherein the substance-containing cavity defines a metering chamber, such that, on moving the plunger into the substance-containing cavity to an actuated position, a metered volume of substance is dispensed to the outlet unit.

9. The applicator unit of claim 1, wherein the applicator element comprises a porous element, a brush element or a blade.

10. An applicator device comprising the applicator unit of claim 1 and a container containing a pharmaceutical product.

11-18. (canceled)
